(19) United States
(12) Patent Application Publication
(10) Pub. No.: US 2025/0293607 A1
(43) Pub. Date: Sep. 18, 2025

(54) ASYMMETRICAL HALF-BRIDGE FLYBACK POWER CONVERSION CIRCUIT THAT CAN DIRECTLY OBTAIN OUTPUT POWER INFORMATION WITHOUT ISOLATION AND CONTROL METHOD THEREOF

(71) Applicant: Richtek Technology Corporation, Zhubei City (TW)

(72) Inventors: Tzu-Chen LIN, Zhubei City (TW); Ta-Yung YANG, Taoyuan City (TW); Chien-Fu TANG, Hsinchu City (TW); Hsin-Yi WU, Zhubei City (TW); Kun-Yu LIN, Zhubei City (TW)

(21) Appl. No.: 19/058,288

(22) Filed: Feb. 20, 2025

Related U.S. Application Data
(60) Provisional application No. 63/565,056, filed on Mar. 14, 2024.

(30) Foreign Application Priority Data
Oct. 24, 2024 (TW) 113140463

(51) Int. Cl. H02M 3/335; H02M 1/00; H02M 1/42

(52) U.S. Cl. CPC H02M 3/33571; H02M 1/0009; H02M 1/0016; H02M 1/4208

(57) ABSTRACT

A power conversion circuit is provided, which includes a transformer, a high-side switch, a low-side switch, and a control circuit. The transformer includes a primary coil and a secondary coil. The secondary coil generates the output voltage of the power conversion circuit. The high-side switch and the low-side switch are coupled to the primary coil and act as a half-bridge circuit to magnetize and demagnetize the transformer. The control circuit individually turns on the high-side switch and the low-side switch based on a feedback signal and a current detection signal to regulate the output voltage. The feedback signal is related with the output voltage, and the current detection signal is indicative of the current flowing through the primary coil. The control circuit further generates a power signal related to the output current of the power conversion circuit.

### CROSS REFERENCE TO RELATED APPLICATIONS

This application claims the benefit of U.S. Provisional Application No. 63/565,056, filed on Mar. 14, 2024, the entirety of which is incorporated by reference herein.

This application claims priority of Taiwan Patent Application No. 113140463, filed on Oct. 24, 2024, the entirety of which is incorporated by reference herein.

### BACKGROUND OF THE INVENTION

### Field of the Invention

The present invention is related to a power conversion circuit and a control method thereof, and more particularly it is related to an asymmetrical half-bridge flyback power conversion circuit and a control method thereof that can directly obtain output power information without isolation.

### Description of the Related Art

A flyback converter is a voltage conversion circuit that is derived from a buck-boost converter. Output voltage is generated by replacing the single-coil inductor of the buck-boost converter with a two-coil transformer, and then rectifying the voltage using a rectifier unit (e.g., a diode).

In order to accurately control the output voltage of a flyback converter, a closed-loop control must be used. If the output power of a flyback converter needs to be controlled more accurately, the output current needs to be detected. However, an output current detection signal needs to be provided to the primary-side control circuit through an isolation device, thereby increasing the complexity of detecting the output current. Therefore, it is necessary to optimize the output current detection method.

### BRIEF SUMMARY OF THE INVENTION

The present invention proposes a power conversion circuit and a control method thereof that can directly obtain output power information without isolation, protect the power conversion circuit through the output power information, and even use the output power information to control the power factor correction circuit of the previous stage, thereby increasing the overall conversion efficiency of the power system.

In an embodiment, a power conversion circuit comprises a transformer, a high-side transistor, a low-side transistor, and a control circuit. The transformer comprises a primary coil and a secondary coil, where the secondary coil generates an output voltage of the power conversion circuit. The high-side transistor and the low-side transistor are coupled to the primary coil and act as a half-bridge circuit to magnetize and demagnetize the transformer. The control circuit individually turns on the high-side switch and the low-side switch based a feedback signal and a current detection signal to regulate the output voltage. The feedback signal is related to the output voltage, and the current detection signal is indicative of a current flowing through the primary coil. The control circuit further generates a power signal related to an output current of the power conversion circuit based on a state of the high-side switch and the feedback signal.

According to an embodiment of the present invention, the control circuit generates the power signal based on a conduction time of the high-side switch, a conduction time of the low-side switch, and the feedback signal.

According to an embodiment of the present invention, the time it takes to magnetize the transformer is equal to the conduction time of the high-side switch. The time it takes to demagnetize the transformer is equal to the conduction time of the low-side switch.

According to an embodiment of the present invention, the control circuit generates the power signal based on an average of the feedback signal.

According to an embodiment of the present invention, the control circuit comprises a low-pass filter. The low-pass filter is configured to average the feedback signal to generate the power signal.

According to an embodiment of the present invention, when the power signal exceeds a threshold, the control circuit drives the high-side switch and the low-side switch to reduce the output current.

According to an embodiment of the present invention, when the power signal exceeds a threshold, the control circuit drives the high-side switch and the low-side switch so that the output current flowing through the secondary coil is a fixed current.

According to an embodiment of the present invention, a power factor correction circuit is configured to convert an AC voltage into an input voltage. The power conversion circuit is configured to convert the input voltage into the output voltage.

According to an embodiment of the present invention, when the power signal exceeds a threshold, the power factor correction circuit raises the input voltage based on the power signal.

According to an embodiment of the present invention, when the power signal does not exceed a threshold, the control circuit disables the power factor correction circuit. When the power signal exceeds the threshold, the control circuit enables the power factor correction circuit.

In another embodiment, a control method for controlling a power conversion circuit is provided. The power conversion circuit comprises a transformer and a half-bridge circuit. The transformer comprises a primary coil and a secondary coil, wherein the half-bridge circuit comprises a high-side switch and a low-side switch for magnetizing and demagnetizing the primary coil respectively, so that the secondary coil generates an output voltage of the power conversion circuit. The control method comprises the following steps. The high-side switch and the low-side switch are individually turned on based on a feedback signal and a current detection signal to regulate the output voltage. A power signal related to an output current of the power conversion circuit is generated based on a state of the high-side switch and the feedback signal. The feedback signal is related to the output voltage, and the current detection signal is indicative of a current flowing through the primary coil.

According to an embodiment of the present invention, the step of generating the power signal related to the output current of the power conversion circuit based on the state of the high-side switch and the feedback signal further comprises the following step. The power signal is generated based on a conduction time of the high-side switch, a conduction time of the low-side switch, and the feedback signal.

According to an embodiment of the present invention, the time it takes to magnetize the transformer is equal to the conduction time of the high-side switch. The time it takes to demagnetize the transformer is equal to the conduction time of the low-side switch.

According to an embodiment of the present invention, the step of generating the power signal related to the output current of the power conversion circuit based on the state of the high-side switch and the feedback signal further comprises the following step. The power signal is generated based on an average of the feedback signal.

According to an embodiment of the present invention, the step of generating the power signal based on the average of the feedback signal further comprises the following step. The feedback signal is averaged by using a low-pass filter to generate the power signal.

According to an embodiment of the present invention, the control method further comprises the following step. When the power signal exceeds a threshold, driving the high-side switch and the low-side switch to reduce the output current.

According to an embodiment of the present invention, the control method further comprises the following step. When the power signal exceeds a threshold, the high-side switch and the low-side switch are driven so that the output current flowing through the secondary coil is a fixed current.

According to an embodiment of the present invention, a power factor correction circuit is configured to convert an AC voltage into an input voltage. The power conversion circuit is configured to convert the input voltage into the output voltage.

According to an embodiment of the present invention, the control method further comprises the following step. When the power signal exceeds a threshold, the power factor correction circuit is controlled to raise the output voltage.

According to an embodiment of the present invention, the control method further comprises the following step. When the power signal does not exceed a threshold, the power factor correction circuit is disabled. When the power signal exceeds the threshold, the power factor correction circuit is enabled.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 is a circuit diagram showing a power conversion circuit in accordance with an embodiment of the present invention;

FIG. 2 is a block diagram showing a control circuit in accordance with an embodiment of the present invention;

FIG. 3 is a block diagram showing a control circuit in accordance with another embodiment of the present invention;

FIG. 4 is a block diagram showing a control circuit in accordance with another embodiment of the present invention;

FIG. 5 is a block diagram showing a determination circuit in accordance with an embodiment of the present invention;

FIG. 6 is a block diagram showing a control circuit in accordance with another embodiment of the present invention;

FIG. 7 is a schematic diagram showing a power system in accordance with an embodiment of the present invention; and

FIG. 8 is a flow chart showing a control method in accordance with an embodiment of the present invention.

### DETAILED DESCRIPTION OF THE INVENTION

The following description is made for the purpose of illustrating the general principles of the disclosure and should not be taken in a limiting sense. The scope of the disclosure is determined by reference to the appended claims.

In the following detailed description, for purposes of explanation, numerous specific details and embodiments are set forth in order to provide a thorough understanding of the present disclosure. The use of like and/or corresponding numerals in the drawings of different embodiments does not suggest any correlation between different embodiments.

In addition, in some embodiments of the present disclosure, terms concerning attachments, coupling and the like, such as “connected” and “interconnected,” refer to a relationship wherein structures are secured or attached to one another either directly or indirectly (for example, electrically connection) via intervening structures, as well as both movable or rigid attachments or relationships, unless expressly described otherwise.

In addition, in this specification, relative spatial expressions are used. For example, “lower”, “bottom”, “higher” or “top” are used to describe the position of one element relative to another. It should be appreciated that if a device is flipped upside down, an element that is “lower” will become an element that is “higher”.

It should be understood that, although the terms first, second, third etc. may be used herein to describe various elements, components, regions, layers, portions and/or sections, these elements, components, regions, layers, portions and/or sections should not be limited by these terms. These terms are only used to distinguish one element, component, region, layer, portion or section from another element, component, region, layer or section. Thus, a first element, component, region, layer, portion or section in the specification could be termed a second element, component, region, layer, portion or section in the claims without departing from the teachings of the present disclosure.

It should be understood that this description of the exemplary embodiments is intended to be read in connection with the accompanying drawings, which are to be considered part of the entire written description. The drawings are not drawn to scale. In addition, structures and devices are shown schematically in order to simplify the drawing.

The terms “approximately”, “about” and “substantially” typically mean a value is within a range of +/−20% of the stated value, more typically a range of +/−10%, +/−5%, +/−3%, +/−2%, +/−1% or +/−0.5% of the stated value. The stated value of the present disclosure is an approximate value. Even there is no specific description, the stated value still includes the meaning of “approximately”, “about” or “substantially”.

Unless defined otherwise, all technical and scientific terms used herein have the same meaning as commonly understood by one of ordinary skill in the art to which this disclosure belongs. It should be appreciated that, in each case, the term, which is defined in a commonly used dictionary, should be interpreted as having a meaning that conforms to the relative skills of the present disclosure and the background or the context of the present disclosure, and should not be interpreted in an idealized or overly formal manner unless so defined.

In addition, in some embodiments of the present disclosure, terms concerning attachments, coupling and the like, such as “connected” and “interconnected,” refer to a relationship wherein structures are secured or attached to one another either directly or indirectly (for example, electrically connection) via intervening structures, as well as both movable or rigid attachments or relationships, unless expressly described otherwise.

In the drawings, similar elements and/or features may have the same reference number. Various components of the same type can be distinguished by adding letters or numbers after the component symbol to distinguish similar components and/or similar features.

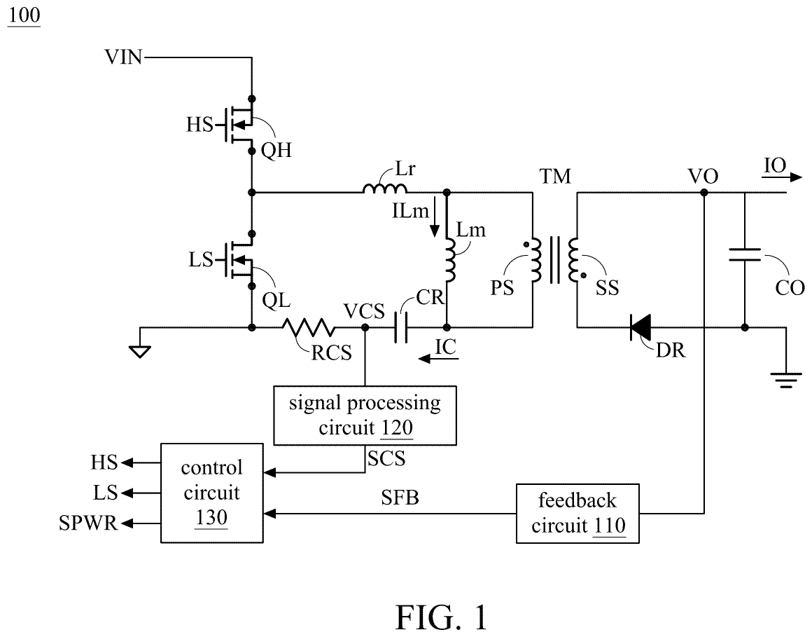

FIG. 1 is a circuit diagram showing a power conversion circuit in accordance with an embodiment of the present invention. As shown in FIG. 1, the power conversion circuit 100 includes a transformer TM, a resonant capacitor CR, a high-side switch QH, a low-bridge switch QL, a current detection resistor RCS, an output capacitor CO, and a rectification unit DR. According to an embodiment of the present invention, the power conversion circuit 100 may be an asymmetrical half-bridge flyback power converter.

The transformer TM includes a primary coil PS and a secondary coil SS, in which the primary coil PS is equivalent to a leakage inductance Lr and a magnetizing inductance Lm. The leakage inductance Lr and the magnetizing inductance Lm are connected in series with each other. The resonant capacitor CR is coupled to one terminal of the primary coil PS.

The high-side switch QH uses the input voltage VIN to magnetize the primary coil PS of the transformer TM and charges the resonant capacitor CR, based on the high-side drive signal HS. The low-side switch QL demagnetizes the transformer TM and discharges the resonant capacitor CR, based on the low-side driving signal LS.

According to an embodiment of the present invention, the high-side switch QH and the low-side switch QL are configured as a half-bridge circuit to store and release energy in the transformer TM and the resonant capacitor CR. According to an embodiment of the present invention, the conduction time of the high-side switch QH is equal to the magnetization time of the transformer TM. According to an embodiment of the present invention, the conduction time of the low-side switch QL is equal to the demagnetization time of the transformer TM. In other words, the conduction time of the low-side switch QL is not fixed.

The current detection resistor RCS is coupled between the resonant capacitor CR and the ground, which is configured to detect the capacitor current IC of the resonant capacitor CS. According to an embodiment of the present invention, the current detection resistor RCS is configured to detect the current flowing through the transformer TM and the resonant capacitor CR when the high-side switch QH is turned on, and to detect the discharge current of the resonant capacitor CR when the low-side switch QL is turned on, thereby generating a current detection voltage VCS. In addition, the current detection voltage VCS is also the voltage across the current detection resistor RCS. When the low-side switch QL is turned on, the transformer TM transfers the energy stored in the primary winding PS and the resonant capacitor CR to the secondary winding SS, and charges the output capacitor CO with the energy of the secondary winding SS through the rectification unit DR to generate the output voltage VO.

As shown in FIG. 1, the power conversion circuit 100 further includes a feedback circuit 110, a signal processing circuit 120, and a control circuit 130. The feedback circuit 110 is configured to generate a feedback signal SFB based on the output voltage VO. In other words, the feedback signal SFB is related to the output voltage VO. According to some embodiments of the present invention, the feedback circuit 110 includes an isolation unit for isolating the signals of the primary winding PS and the secondary winding SS of the transformer TM.

The signal processing circuit 120 generates a current detection signal SCS based on the current detection voltage VCS. In other words, the current detection signal SCS represents the current flowing through the primary coil PS. The control circuit 130 generates a high-side driving signal HS and a low-side driving signal LS to drive the high-side switch QH and the low-side switch QL respectively, based on the feedback signal SFB related to the output voltage VO and the current detection signal SCS representing the current flowing through the primary coil PS, thereby adjusting the output voltage VO.

As shown in FIG. 1, the relationship between the output voltage VO and the input voltage VIN is as shown in Eq. 1, where the primary coil PS has a primary number of turns Np, the secondary coil SS has a secondary number of turns Ns, the conduction time of the high-side switch QH is t_{QH}, and the conduction time of the low-side switch QL is t_{QL}.

$$\frac{VO}{VIN} = \frac{D}{N} \cdot \frac{L m}{L m + L r} \qquad ( Eq . 1 )$$

$$N = \frac{N p}{Ns}$$

$$D = \frac{{t}_{Q H}}{{t}_{QH} + {t}_{QL}}$$

When the power conversion circuit 100 operates in the critical resonance mode (CRM), the output current IO of the power conversion circuit 100 is shown in Eq. 2, where ILm,max and ILm,min are respectively the maximum value and the minimum value of the magnetizing current ILm flowing through the magnetizing inductor Lm. According to an embodiment of the present invention, ILm,min may be a negative value.

$${IO}_{CRM} = \frac{1}{2} \cdot N \cdot ( ILm , max + ILm , min ) \qquad ( Eq . 2 )$$

When the power conversion circuit 100 operates in the discontinuous current mode (DCM), the output current IO of the power conversion circuit 100 is shown in Eq. 3, where tₛ represents the sum of the conduction time of the driving high-side switch QH, the conduction time of the low-side switch QL, and the time when both the high-side switch QH and the low-side switch QL are off. The conduction time of the high-side switch QH is t_{QH}, and the conduction time of the low-side switch QL is t_{QL}.

$${IO}_{DCM} = \frac{1}{2} \cdot \frac{{t}_{QH} + {t}_{QL}}{{t}_{S}} \cdot N \cdot ( ILm , max + ILm , min ) \qquad ( Eq . 3 )$$

According to an embodiment of the present invention, when the feedback signal SFB is equal to the current detection signal VCS, the control circuit 130 turns off the high-side switch QH. In other words, the feedback signal SFB can be regarded as being equal to the maximum value of the current flowing through the magnetizing inductor Lm, which is used to approximate the value of

$$\frac{1}{2} \cdot N \cdot ( ILm , max + ILm , min ) .$$

That is, the control circuit 130 can know the magnitude of the output current IO by using the feedback signal SFB. As shown in FIG. 1, the control circuit 130 generates a power signal SPWR based on the high-side driving signal HS and the feedback signal SFB, where the power signal SPWR is related to the output current IO.

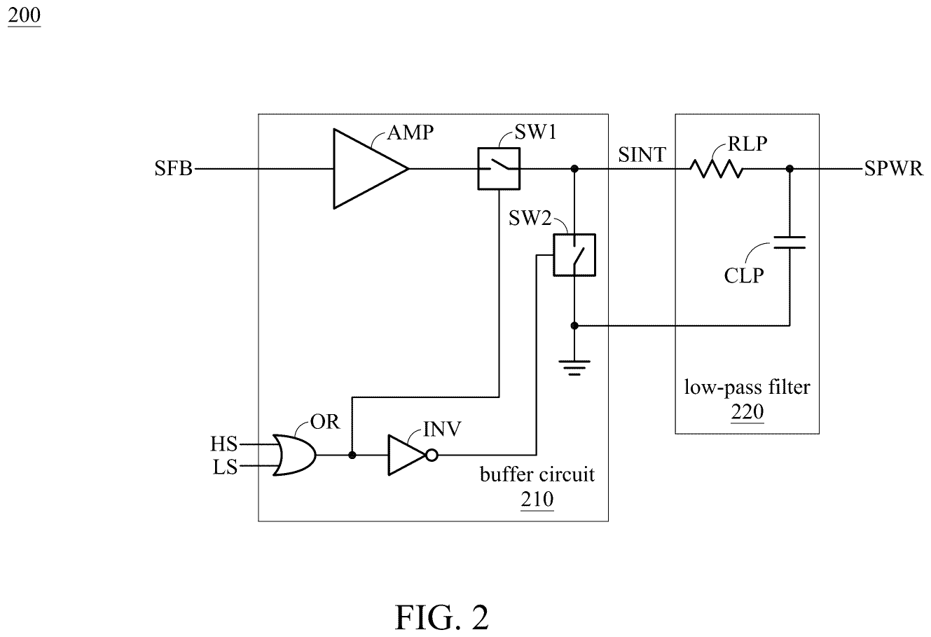

FIG. 2 is a block diagram showing a control circuit in accordance with an embodiment of the present invention. As shown in FIG. 2, the control circuit 200 includes a buffer circuit 210 and a low-pass filter 220. The buffer circuit 210 includes an amplifier AMP, an OR gate OR, a first switch SW1, an inverter INV, and a second switch SW2. The amplifier AMP is configured to increase the current driving capability of the feedback signal SFB. The OR gate OR is configured to perform a logic OR operation on the high-side driving signal HS and the low-side driving signal LS to turn on the first switch SW1. The inverter INV is configured to invert the output of the OR gate OR to turn on the second switch SW2.

According to an embodiment of the present invention, when the high-side switch QH or the low-side switch QL is turned on, the high-side driving signal HS or the low-side driving signal LS is in an enabled state, thereby turning on the first switch SW1 and providing the feedback signal SFB to the transmission signal SINT. According to another embodiment of the present invention, when the high-side driving signal HS and the low-side driving signal LS are both disabled and the high-side switch QH or the low-side switch QL is turned off, the second switch SW2 is turned on to discharge the transmission signal SINT.

As shown in FIG. 2, the low-pass filter 220 includes a low-pass resistor RLP and a low-pass capacitor CLP. The low-pass resistor RLP is coupled between the transmission signal SINT and the power signal SPWR, and the low-pass capacitor CLP is coupled between the power signal SPWR and the ground. According to an embodiment of the present invention, the low-pass filter 220 is configured to average the feedback signal SFB to generate the power signal SPWR. According to some embodiments of the present invention, the power signal SPWR is proportional to the output current IO of the power conversion circuit 100.

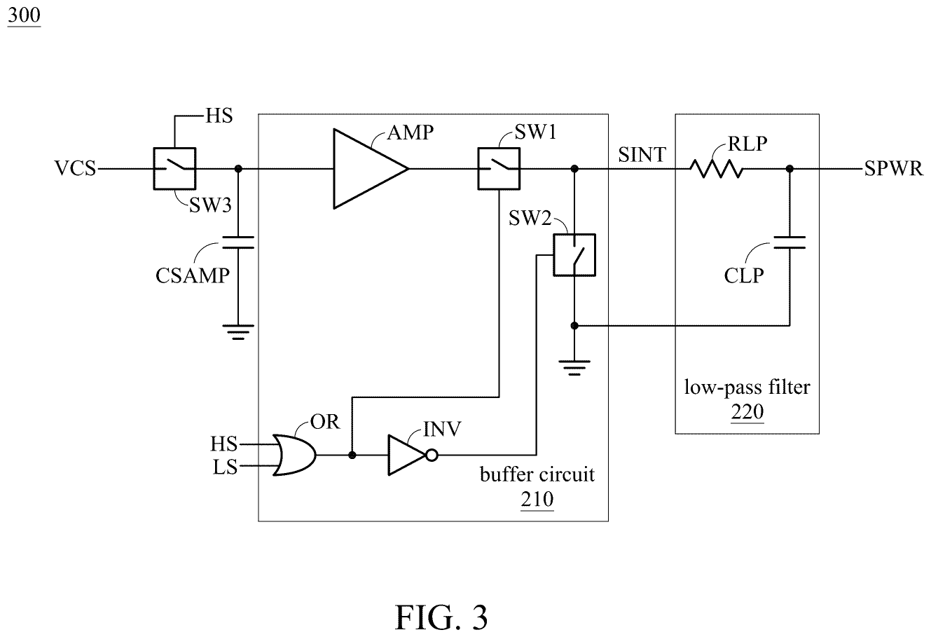

FIG. 3 is a block diagram showing a control circuit in accordance with another embodiment of the present invention. Comparing the control circuit 300 of FIG. 3 with the control circuit 200 of FIG. 2, the control circuit 300 further includes a third switch SW3 and a sampling capacitor CSAMP, where the third switch SW3 is configured to capture the maximum value of the current detection voltage VCS based on the high-side driving signal HS and store it in the sampling capacitor CSAMP. Then, the maximum value of the detection voltage VCS stored in the sampling capacitor CSAMP is provided to the buffer circuit 210.

According to an embodiment of the present invention, since the output current IO is related to the maximum value of the capacitor current IC (equivalent to the magnetizing current ILm) when the high-side switch is turned on, and the capacitor current IC is represented by the current detection voltage VCS, the maximum value of the captured current detection voltage VCS is equivalent to the maximum value of the captured capacitor current IC. In other words, the power signal SPWR generated by the control circuit 300 is proportional to the output current IO.

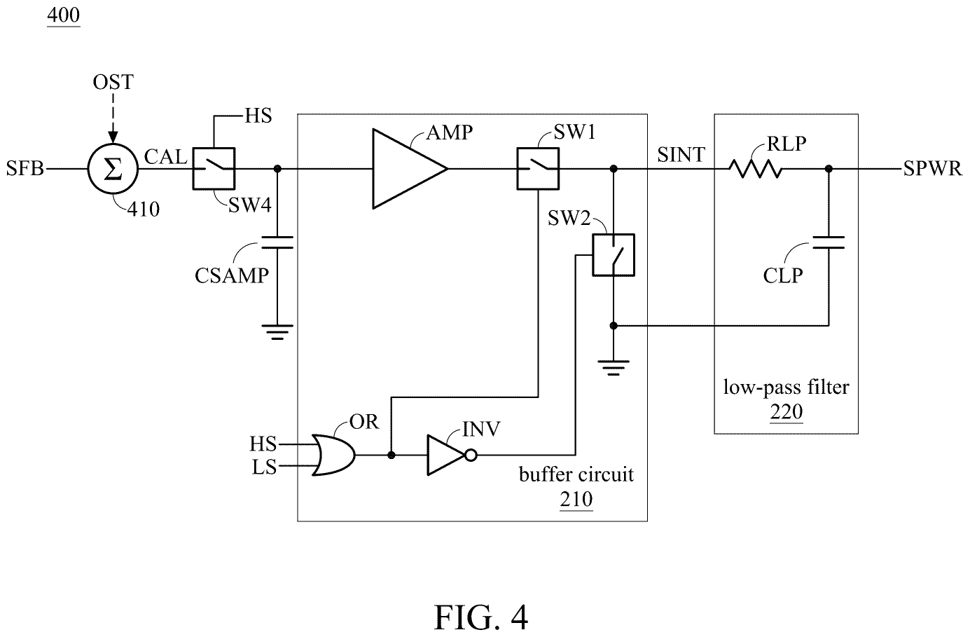

FIG. 4 is a block diagram showing a control circuit in accordance with another embodiment of the present invention. Compared the control circuit 400 in FIG. 4 with the control circuit 200 in FIG. 2, the control circuit 400 further includes a calculation circuit 410 and a fourth switch SW4. The calculation circuit 410 is configured to subtract the offset OFT from the feedback signal SFB to generate a calibration signal CAL.

According to some embodiments of the present invention, since there is still some offset OFT between the feedback signal SFB and the maximum value of the current detection signal SCS, and the offset OFT is related to the input voltage VIN or to the sawtooth signal (ramp), the operation of the calculation circuit 410 can make the feedback signal SFB much closer to the current detection signal SCS. According to some embodiments of the present invention, the offset OFT may be obtained by multiplying the input voltage VIN by a ratio. According to another embodiment of the present invention, the offset OFT may also be configured for slope compensation. According to other embodiments of the present invention, the offset may be the slope compensation plus the input voltage VIN multiplied by a ratio.

Next, the fourth switch SW4 provides the correction signal CAL to the buffer circuit 210 and the low-pass filter 220 based on the high-side driving signal HS (i.e., the conduction time of the high-side switch QH), thereby generating a power signal SPWR proportional to the output current IO.

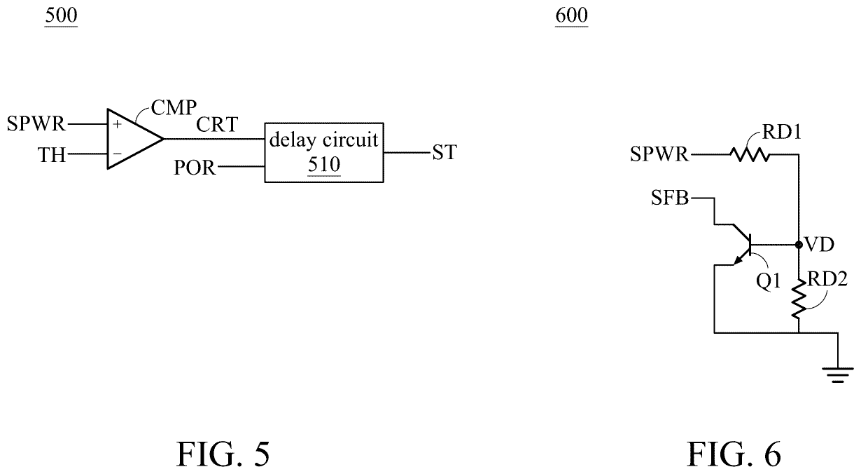

FIG. 5 is a block diagram showing a determination circuit in accordance with an embodiment of the present invention. According to an embodiment of the present invention, the control circuit 130 of FIG. 1 further includes a determination circuit 500. As shown in FIG. 5, the determination circuit 500 includes a comparator CMP and a delay circuit 510. The comparator CMP is configured to compare the power signal SPWR with the threshold TH to generate a comparison result CRT. According to an embodiment of the present invention, when the power signal SPWR exceeds the threshold TH, the comparator CMP outputs a comparison result CRT being enabled. According to another embodiment of the present invention, when the power signal SPWR does not exceed the threshold value TH, the comparator CMP outputs the comparison result CRT being disabled.

When the comparison result CRT changes, the delay circuit 510 is configured to delay for a predetermined time before outputting the comparison result CRT as the state signal ST. According to an embodiment of the present invention, when the status signal ST is enabled, it means that the power conversion circuit 100 is in an over-current state. The control circuit 130 can perform protection on the power conversion circuit 100 based on the enabled status signal ST. According to an embodiment of the present invention, the control circuit 130 reduces the output current IO by controlling the high-side switch QH and the low-side switch QL based on the enabled status signal ST.

As shown in FIG. 5, the delay circuit 510 further receives a power-on reset signal POR. For example, when the input voltage VIN in FIG. 1 gradually rises from 0V to a certain level, the power-on reset signal POR generates a pulse to reset the state signal ST of the delay circuit 510.

FIG. 6 is a block diagram showing a control circuit in accordance with another embodiment of the present invention. According to an embodiment of the present invention, the control circuit 600 corresponds to the control circuit 130 in FIG. 1. As shown in FIG. 6, the control circuit 600 further includes a first voltage-dividing resistor RD1, a second voltage-dividing resistor RD2, and a first transistor Q1. The first voltage-dividing resistor RD1 and the second voltage-dividing resistor RD2 are configured to divide the power signal SPWR to generate a divided voltage VD. When the divided voltage VD turns on the first transistor Q1 as the power signal SPWR increases, the first transistor Q1 pulls down the feedback signal SFB.

According to an embodiment of the present invention, when the current detection signal SCS exceeds the feedback signal SFB, the control circuit 600 turns off the high-side switch QH. In other words, when the power signal SPWR increases to pull the feedback signal SFB low, the conduction time of the high-side switch QH decreases accordingly, thereby reducing the output current IO. On the other hand, when the power signal SPWR increases to pull the feedback signal SFB low, the output current IO flowing through the secondary winding SS of the transformer TM is kept constant by reducing the conduction time of the high-side switch QH.

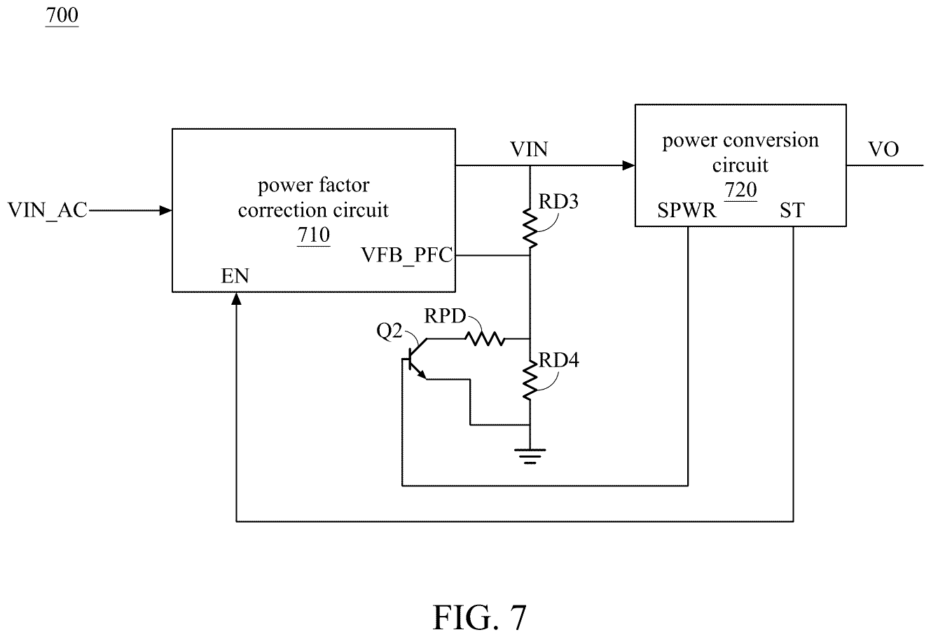

FIG. 7 is a schematic diagram showing a power system in accordance with an embodiment of the present invention. As shown in FIG. 7, the power system 700 includes a power factor correction circuit 710 and a power conversion circuit 720. According to an embodiment of the present invention, the power conversion circuit 720 corresponds to the power conversion circuit 100 in FIG. 1.

As shown in FIG. 7, the power factor correction circuit 710 is configured to convert the AC input voltage VIN_AC into an input voltage VIN. In addition, the input voltage VIN is divided by the third voltage-dividing resistor RD3 and the fourth voltage-dividing resistor RD4 to generate the power factor feedback voltage VFB_PFC. The power factor correction circuit 710 further adjusts the voltage value of the input voltage VIN based on the power factor feedback voltage VFB_PFC. According to an embodiment of the present invention, when the power factor feedback voltage VFB_PFC decreases, the power factor correction circuit 710 increases the voltage value of the input voltage VIN.

The power conversion circuit 720 is configured to convert the input voltage VIN into the output voltage VO, and to generate a state signal ST and a power signal SPWR. According to some embodiments of the present invention, the state signal ST corresponds to the state signal ST of FIG. 5, and the power signal SPWR corresponds to the power signal SPWR in FIGS. 2-6, which will not be repeated herein.

According to an embodiment of the present invention, when the power signal SPWR turns on the second transistor Q2, the second transistor Q2 and the pull-down resistor RPD are configured to pull down the power factor feedback voltage VFB_PFC, so that the power factor correction circuit 710 further increases the input voltage VIN. When the power signal SPWR turns on the second transistor Q2, it means that the power conversion circuit 720 is generating a larger output power, and the power factor correction circuit 710 increases the input voltage VIN to improve the conversion efficiency of the power conversion circuit 720.

According to an embodiment of the present invention, when the power signal SPWR is lower than the threshold value TH and the status signal ST is disabled (as shown in FIG. 5), the disabled status signal ST is used as the enable signal EN of the power factor correction circuit 710 to disable the power factor correction circuit 710, thereby increasing the conversion efficiency of the power system 700 under light load conditions.

According to another embodiment of the present invention, when the power signal SPWR is not less than the threshold value TH to enable the status signal ST (as shown in FIG. 5), the enabled status signal ST is used as the enable signal EN of the power factor correction circuit 710 to enable the power factor correction circuit 710. Even a higher power signal SPWR can further prompt the power factor correction circuit 710 to increase the input voltage VIN and to increase the conversion efficiency of the power system 700.

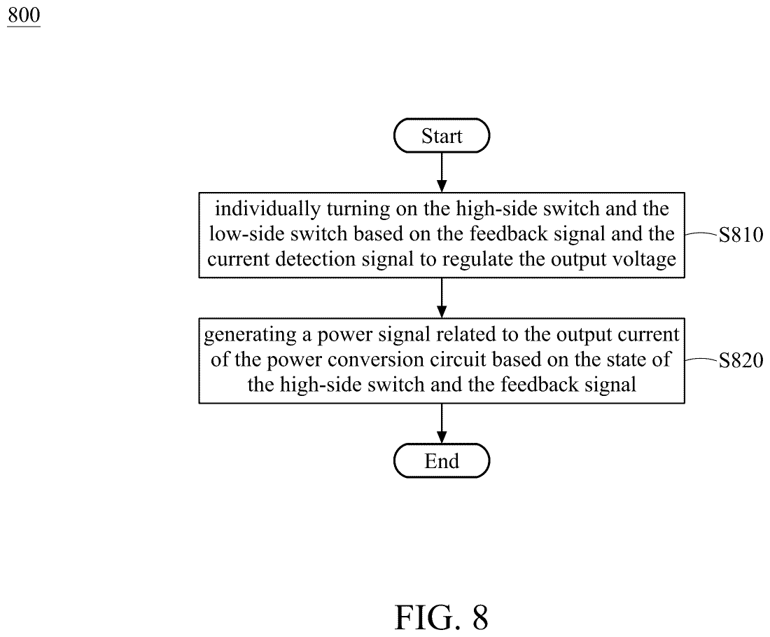

FIG. 8 is a flow chart showing a control method in accordance with an embodiment of the present invention. According to some embodiments of the present invention, the control method 800 of FIG. 8 is configured to control the power conversion circuit 100 of FIG. 1. The following description of the control method 800 will be combined with the power conversion circuit 100 of FIG. 1 for detailed description.

First, the control circuit 130 turns on the high-side switch QH and the low-side switch QL respectively based on the feedback signal SFB and the current detection signal SCS to adjust the output voltage VO (step S810). Next, the control circuit 130 generates a power signal SPWR related to the output current IO of the power conversion circuit 100 based on the state of the high-side switch QH and the feedback signal SFB (step S820). According to an embodiment of the present invention, the control circuit 130 generates the power signal SPWR based on the conduction time of the high-side switch QH and the feedback signal SFB.

The present invention proposes a power conversion circuit and a control method thereof that can directly obtain output power information without isolation, protect the power conversion circuit through the output power information, and even use the output power information to control the power factor correction circuit of the previous stage, thereby increasing the overall conversion efficiency of the power system.

Although some embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A power conversion circuit, comprising:
a transformer, comprising a primary coil and a secondary coil, wherein the secondary coil generates an output voltage of the power conversion circuit;
a high-side transistor and a low-side transistor, coupled to the primary coil and acting as a half-bridge circuit to magnetize and demagnetize the transformer; and
a control circuit, individually turning on the high-side switch and the low-side switch based a feedback signal and a current detection signal to regulate the output voltage;
wherein the feedback signal is related to the output voltage, and the current detection signal is indicative of a current flowing through the primary coil;
wherein the control circuit further generates a power signal related to an output current of the power conversion circuit based on a state of the high-side switch and the feedback signal.

2. The power conversion circuit as claimed in claim 1, wherein the control circuit generates the power signal based on a conduction time of the high-side switch, a conduction time of the low-side switch, and the feedback signal.

3. The power conversion circuit as claimed in claim 1, wherein a time for magnetizing the transformer is equal to the conduction time of the high-side switch;
wherein a time for demagnetizing the transformer is equal to the conduction time of the low-side switch.

4. The power conversion circuit as claimed in claim 1, wherein the control circuit generates the power signal based on an average of the feedback signal.

5. The power conversion circuit as claimed in claim 4, wherein the control circuit comprises a low-pass filter;
wherein the low-pass filter is configured to average the feedback signal to generate the power signal.

6. The power conversion circuit as claimed in claim 1, wherein when the power signal exceeds a threshold, the control circuit drives the high-side switch and the low-side switch to reduce the output current.

7. The power conversion circuit as claimed in claim 1, wherein when the power signal exceeds a threshold, the control circuit drives the high-side switch and the low-side switch so that the output current flowing through the secondary coil is a fixed current.

8. The power conversion circuit as claimed in claim 1, wherein a power factor correction circuit is configured to convert an AC voltage into an input voltage;
wherein the power conversion circuit is configured to convert the input voltage into the output voltage.

9. The power conversion circuit as claimed in claim 8, wherein when the power signal exceeds a threshold, the power factor correction circuit raises the input voltage based on the power signal.

10. The power conversion circuit as claimed in claim 8, wherein when the power signal does not exceed a threshold, the control circuit disables the power factor correction circuit;
wherein when the power signal exceeds the threshold, the control circuit enables the power factor correction circuit.

11. A control method for controlling a power conversion circuit, wherein the power conversion circuit comprises a transformer and a half-bridge circuit, wherein the transformer comprises a primary coil and a secondary coil, wherein the half-bridge circuit comprises a high-side switch and a low-side switch for magnetizing and demagnetizing the primary coil respectively, so that the secondary coil generates an output voltage of the power conversion circuit, wherein the control method comprises:
individually turning on the high-side switch and the low-side switch based on a feedback signal and a current detection signal to regulate the output voltage; and
generating a power signal related to an output current of the power conversion circuit based on a state of the high-side switch and the feedback signal;
wherein the feedback signal is related to the output voltage, and the current detection signal is indicative of a current flowing through the primary coil.

12. The control method as claimed in claim 11, wherein the step of generating the power signal related to the output current of the power conversion circuit based on the state of the high-side switch and the feedback signal further comprises:
generating the power signal based on a conduction time of the high-side switch, a conduction time of the low-side switch, and the feedback signal.

13. The control method as claimed in claim 12, wherein a time for magnetizing the transformer is equal to the conduction time of the high-side switch;
wherein a time for demagnetizing the transformer is equal to the conduction time of the low-side switch.

14. The control method as claimed in claim 11, wherein the step of generating the power signal related to the output current of the power conversion circuit based on the state of the high-side switch and the feedback signal further comprises:
generating the power signal based on an average of the feedback signal.

15. The control method as claimed in claim 14, wherein the step of generating the power signal based on the average of the feedback signal further comprises:
averaging the feedback signal by using a low-pass filter to generate the power signal.

16. The control method as claimed in claim 11, further comprising:
when the power signal exceeds a threshold, driving the high-side switch and the low-side switch to reduce the output current.

17. The control method as claimed in claim 11, further comprising:
when the power signal exceeds a threshold, driving the high-side switch and the low-side switch so that the output current flowing through the secondary coil is a fixed current.

18. The control method as claimed in claim 11, wherein a power factor correction circuit is configured to convert an AC voltage into an input voltage;
wherein the power conversion circuit is configured to convert the input voltage into the output voltage.

19. The control method as claimed in claim 18, further comprising:
when the power signal exceeds a threshold, controlling the power factor correction circuit to raise the output voltage.

20. The control method as claimed in claim 18, further comprising:
when the power signal does not exceed a threshold, disabling the power factor correction circuit; and
when the power signal exceeds the threshold, enabling the power factor correction circuit.
